(19) United States
(12) Patent Application Publication
(10) Pub. No.: US 2006/0017862 A1
(43) Pub. Date: Jan. 26, 2006

(54) Liquid crystal display device built-in finger printing device and method of manufacturing the same

(76) Inventors: Jean-Ho Song, Gyeonggi-do (KR); Joon-Hoo Choi, Seoul (KR); Sung-Hoon Yang, Seoul (KR); Chong-Chul Chai, Seoul (KR)

Correspondence Address: CANTOR COLBURN, LLP, 55 GRIFFIN ROAD SOUTH, BLOOMFIELD, CT, 06002, US

(21) Appl. No.: 10/531,829

(22) PCT Filed: Aug. 30, 2003
(86) PCT No.: PCT/KR03/01768

§ 371 Date: Apr. 18, 2005

(30) Foreign Application Priority Data
Oct. 17, 2002 (KR) 10-2002-0063370

(51) Int. Cl. G02F 1/136

(52) U.S. Cl. 349/42

(57) ABSTRACT

A liquid crystal display device having fingerprint identification device for enhancing aperture ratio and transmissivity of a TFT-LCD panel is disclosed. A fingerprint identification substrate (400) is attached to a TFT substrate (300). The TFI substrate has color-filter-on-array structure in which the color filters (336) and the thin film transistors can be eliminated, the aperture ratio is increased, and the quality of image display is enhanced. In addition, the transmissivity is increased according to the decrease of the number of glass substrate used in the liquid crystal display device, so that the sensitivity of fingerprint identification is enhanced.

### TECHNICAL FIELD

The disclosure relates to a liquid crystal display device having a built-in fingerprint identification device and a method of manufacturing the liquid crystal display device.

### BACKGROUND ART

An a-Si thin film transistor liquid crystal display (TFT-LCD) device is a flat panel display (FPD). The a-Si TFT-LCD device is used in a laptop computer, a monitor, a television set and a mobile phone.

The a-Si TFT-LCD device displays an image by means of switch thin film transistors. In addition, the a-Si TFT-LCD device has a photosensitive property and is used as an optical sensor in the field of biometrics.

In a personal authentication system, especially a fingerprint identification method using fingerprint identification devices is widely used because the fingerprint identification method may be accomplished at a low cost and has characteristics of high availability and high accuracy.

The conventional fingerprint identification device may be divided into an optical fingerprint identification device employing an optical sensor and a semiconductor type fingerprint identification device employing semiconductor sensors.

The optical fingerprint identification device provides a high quality of fingerprint image. However, the optical fingerprint identification device is sensitive to distortion of images, cannot be easily miniaturized and is manufactured at a high cost. Particularly, the optical fingerprint identification device is not suitable for mobile devices such as a cellular phone because the optical fingerprint identification device uses a plurality of lens such that the optical fingerprint identification device cannot be easily thinner and lighter.

The semiconductor type fingerprint identification device manufactured by a complementary metal oxide semiconductor (CMOS) process may be easily miniaturized. However, the fingerprint identification device manufactured by the CMOS process is sensitive to a static electricity and an external environment and has a low reliability. The fingerprint identification devices used in the mobile devices should have a thinner and lighter structure, long endurance and high reliability.

Recently, a-Si TFT fingerprint identification device satisfying the requirement for the mobile devices has been developed. The a-Si TFT fingerprint identification device uses a photosensitive property of a-Si channel in the a-Si TFT. The a-Si TFT fingerprint identification device has a relatively thin structure and has a high photosensitive property during the sensor operation.

In addition, a TFT-LCD device employing the a-Si TFT fingerprint identification device has been used in a cellular phone.

FIG. 1 is a perspective view showing a cellular (or mobile) phone having an a-Si TFT-LCD panel mounted with a TFT fingerprint identification substrate, and FIG. 2 is a cross-sectional view showing an a-Si TFT-LCD panel mounted with a TFT fingerprint identification substrate of FIG. 1.

Referring to FIGS. 1 and 2, a TFT fingerprint identification substrate 10 using a-Si TFT is attached to a TFT-LCD panel 20. The TFT-LCD panel 20 includes a color filter substrate having a plurality of color filters and a TFT substrate.

The TFT fingerprint identification substrate 10 includes a first transparent substrate 12, a fingerprint identification thin film transistor 14 and an inter-layer insulation film 16. The first transparent substrate comprises a transparent material such as glass. The fingerprint identification thin film transistor 14 is formed on the first transparent substrate 12 and includes a sensor TFT for sensing a fingerprint pattern and a switch TFT. The inter-layer insulation film 16 is formed on the resultant structure.

The conventional TFT-LCD panel 20 includes a TFT substrate 25, a color filter substrate 32 and a liquid crystal layer 35 interposed between the TFT substrate 25 and the color filter substrate 32. The TFT substrate 25 includes thin film transistors (not shown) formed on a second transparent substrate 22 comprised of a transparent material such as glass. The color filter substrate 32 includes red (R), green (G) and blue (B) color filters formed on a third transparent substrate 34 comprised of a transparent material such as glass. The color filter substrate 32 is attached to the TFT substrate 25 to be opposite to the TFT substrate 25 while the liquid crystal layer 35 is interposed between the color filter substrate 32 and the TFT substrate 25.

The TFT fingerprint identification substrate 10 usually has a higher resolution than the TFT-LCD panel 20 for the purpose of accurate fingerprint identification operation. For example, n unit cells of TFTs having an aspect ratio of 1:1 corresponds to one pixel of the TFT-LCD panel having an aspect ratio of 1:n. Namely, n unit cells of TFTs having the aspect ratio of 1:1 are arranged over one pixel of the TFT-LCD panel having the aspect ratio of 1:n.

For example, a resolution of the TFT fingerprint identification substrate 10 is larger than that of the TFT-LCD panel 20 by n times. When the TFT fingerprint identification substrate 10 is not exactly aligned with the TFT-LCD panel 20, an aperture ratio of the TFT fingerprint identification substrate 10 may decrease by n times compared with that of the TFT-LCD panel 20.

Particularly, the aperture ratio is greatly decreased when the TFT substrate 25 of the TFT-LCD panel 20 is not exactly aligned with the color filter substrate 32 of the TFT-LCD panel 20. Accordingly, little design margin may be left and management for manufacture process may be difficult.

In addition, exact aligning process may not be easily performed, and quality of image may be deteriorated due to the decrease in the aperture ratio when the TFT-LCD panel 20 mounted with the TFT fingerprint identification substrate 10 is designed in consideration of the miss-align between substrates.

### DISCLOSURE OF THE INVENTION

Accordingly, the present invention is provided to substantially obviate one or more problems due to limitations and disadvantages of the related art.

It is a first feature of the present invention to provide a liquid crystal display device including a built-in fingerprint identification device, which has enhanced light transmissivity and increased aperture ratio by decreasing the miss-alignment between substrates.

It is a second feature of the present invention to provide a process of manufacturing a liquid crystal display device including a built-in fingerprint identification device, which has enhanced light transmissivity and increased aperture ratio by decreasing the miss-alignment between substrates.

According to one aspect of the first feature of the invention, there is provided a liquid crystal display device comprising: a first substrate including a plurality of unit cells, each of the unit cells having i) a sensor thin film transistor for receiving a light reflected from a fingerprint to generate electric charges corresponding to an intensity of the reflected light, ii) a storage device for storing the electric charges, iii) a first switch thin film transistor for receiving the electric charges from the storage device to output the electric charges in response to an external control signal; a first transparent electrode disposed on a lower surface of the first substrate; a second substrate including a pixel, the pixel having i) a second switch thin film transistor, ii) a data line electrically coupled with a first electrode of the second switch thin film transistor, iii) a gate line electrically coupled with a second electrode of the second switch thin film transistor, iv) a color filter layer formed on first portions of the gate line, the data line and the second switch thin film transistor, v) a second transparent electrode formed on the color filter layer and electrically coupled with a second portion of the first electrode; and a liquid crystal layer interposed between the first and second substrates.

According to another aspect of the first feature of the invention, there is provided a liquid crystal display device comprising: a first substrate including a plurality of unit cells, each of the unit cells having i) a sensor thin film transistor for receiving a light reflected from a fingerprint to generate electric charges corresponding to an intensity of the reflected light, ii) a storage device for storing the electric charges, iii) a first switch thin film transistor for receiving the electric charges from the storage device to output the electric charges in response to an external control signal; a first transparent electrode disposed on a lower surface of the first substrate; a second substrate; a pixel including i) a data wiring having a data line formed in the second substrate, ii) a color filter layer on the second substrate on which the data wiring is formed, the color filter layer covering a first portion of the data wiring, iii) an insulation layer covering the data wiring and the color filter layer, iv) a second switch thin film transistor formed on the insulation layer, and v) a second transparent electrode electrically coupled with a second portion of a first electrode of the second switch thin film transistor; and a liquid crystal layer interposed between the first and second substrates.

To accomplish the second feature of the invention, there is provided a method of manufacturing the liquid crystal display device, the method comprising: forming a sensor thin film transistor, a storage device and a first switch thin film transistor and on a first substrate comprised of an insulation material, the sensor thin film transistor receiving a light reflected from a fingerprint to generate electric charges corresponding to an intensity of the reflected light, the storage device storing the electric charges, and the first switch thin film transistor receiving the electric charges from the storage device to output the electric charges in response to an external control signal; forming a first transparent electrode on a lower surface of the first substrate; forming a second switch thin film transistor on a second substrate comprised of insulation material; forming a color filter layer on the second switch thin film transistor; forming a second transparent electrode on the color filter layer; aligning the first substrate over the second substrate base on a first aspect ratio for a first pixel unit of the first substrate and a second aspect ratio for a second pixel unit of the second substrate; and forming a liquid crystal layer between the first and second substrates.

According to the present invention, there is provided a liquid crystal display device in which the fingerprint identification device having sensor TFT for sensing the fingerprint is mounted on the TFT-LCD panel. The TFT-LCD panel has color-filter-on-array (COA) structure in which the color filters are self-aligned with the thin film transistors.

Accordingly, when the fingerprint identification device having the sensor TFT is mounted on the TFT-LCD panel, the number of glass substrate can be reduced such that the manufacturing cost may be reduced. The liquid crystal display device according to the present invention requires only two glass substrates while the conventional liquid crystal display device requires three glass substrates. Particularly, when the liquid crystal display device is employed in the mobile devices such as the cellular phone, the thickness and total weight of the mobile device can be reduced.

In addition, the transmissivity of the TFT-LCD panel having the fingerprint identification device is increased according to the decrease of the number of glass substrate, so that the sensitivity of fingerprint identification can be enhanced.

In addition, in the TFT-LCD panel having the fingerprint identification device, the TFT substrate has the color-filter-on-array structure. Accordingly, the miss-alignment between the color filters and the thin film transistors can be eliminated, the aperture ratio of the TFT-LCD panel having the fingerprint identification device can be increased, and the quality of image display can be enhanced.

In addition, when the liquid crystal display device having the fingerprint identification device is designed and manufactured, the design margin can be increased, and management for manufacturing process may be proceeded easily.

### BRIEF DESCRIPTION OF THE DRAWINGS

The above and other advantages of the present invention will become more apparent by describing in detail exemplary embodiments thereof with reference to the accompanying drawings, in which:

FIG. 1 is a perspective view showing a cellular phone having an a-Si TFT-LCD panel mounted with a TFT fingerprint identification substrate;

FIG. 2 is a cross-sectional view showing an a-Si TFT-LCD panel mounted with a TFT fingerprint identification substrate of FIG. 1;

FIG. 3 is a cross-sectional view showing a color-filter-on-array structure of an a-Si TFT-LCD panel mounted with a TFT fingerprint identification substrate according to one exemplary embodiment of the present invention;

FIG. 4 is a cross-sectional view showing a unit cell of the TFT fingerprint identification substrate of FIG. 3;

FIG. 5 is an equivalent circuit diagram showing a unit cell of the TFT fingerprint identification substrate of FIG. 4;

FIG. 6 is a schematic block diagram showing an arrangement between a TFT fingerprint identification substrate, a TFT substrate having a color-filter-on-array structure, a gate driver integrating circuit and a data driver integrating circuit according to one exemplary embodiment of the present invention;

FIG. 7 is a plan view showing a unit cell of the TFT fingerprint identification substrate of FIG. 4;

FIG. 8 is a cross-sectional view taken along a line A-A′ of FIG. 7;

FIGS. 9A to 14C are plan views and cross-sectional views illustrating a process of manufacturing a unit cell of the TFT fingerprint identification substrate of FIG. 7;

FIG. 15A is a plan view showing a pixel of the TFT fingerprint identification substrate of FIG. 3;

FIG. 15B is a cross-sectional view taken along a line B-B′ of FIG. 15A;

FIG. 15C is a cross-sectional view taken along a line C-C′ of FIG. 15A; and

FIGS. 16A to 20C are plan views and cross-sectional views illustrating a process of manufacturing a pixel of the TFT fingerprint identification substrate of FIG. 15A.

FIG. 21 is a cross-sectional view showing a pixel of the TFT-LCD panel mounted with a TFT fingerprint identification substrate of FIG. 3 according to another exemplary embodiment of the present invention;

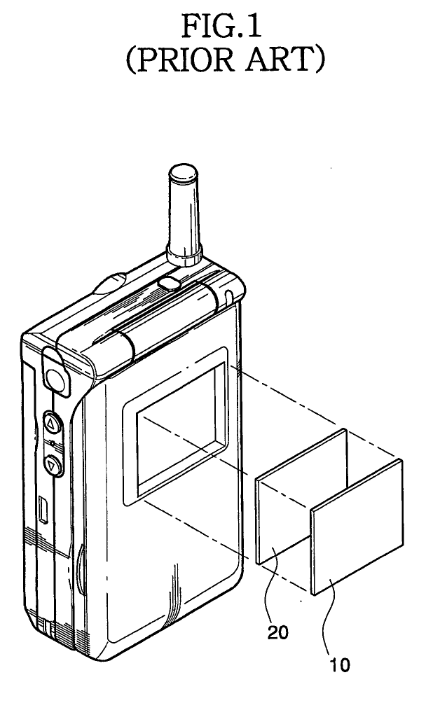

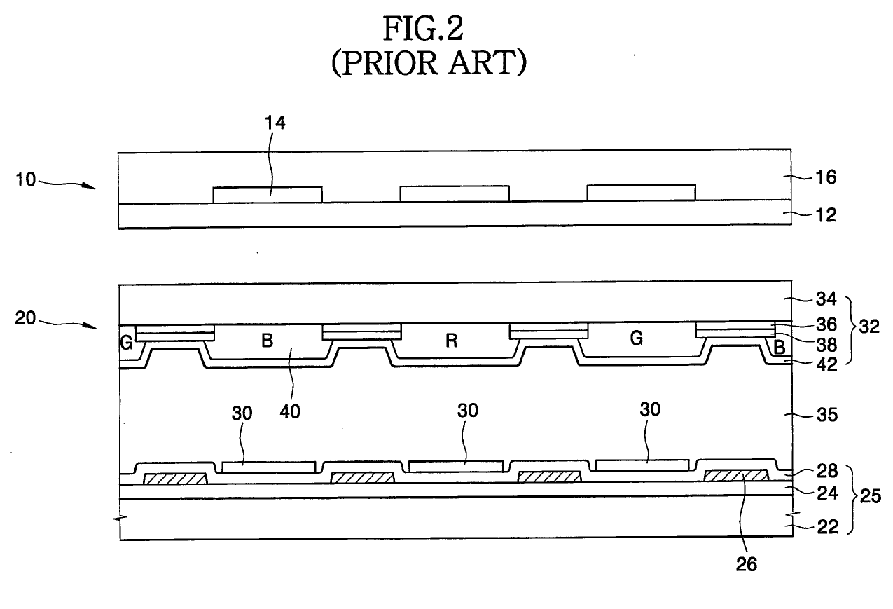

### BEST MODE FOR CARRYING OUT THE INVENTION

Hereinafter the preferred embodiment of the present invention will be described in detail with reference to the accompanying drawings.

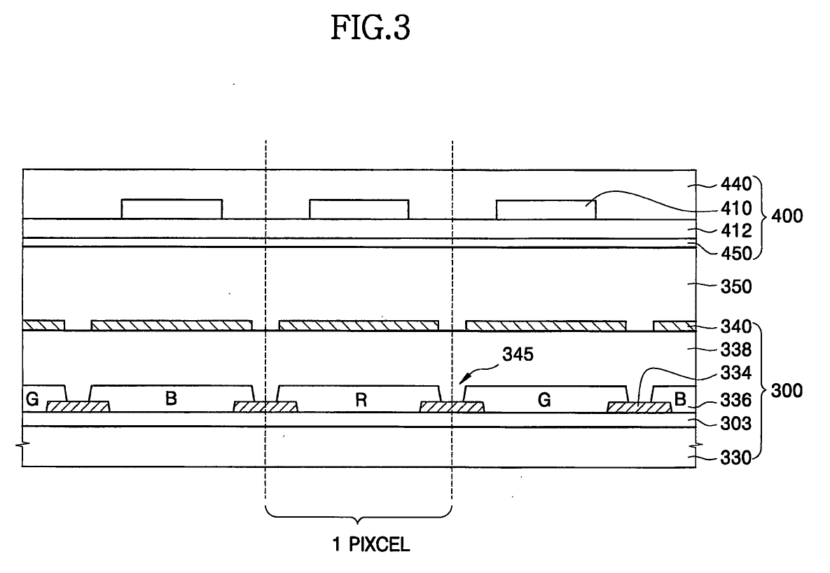

FIG. 3 is a cross-sectional view showing a color-filter-on-array structure of an a-Si TFT-LCD panel mounted with a TFT fingerprint identification substrate according to one exemplary embodiment of the present invention.

The color-filter-on-array structure is referred to as a structure in which color filters are formed on the TFT substrate to be aligned with thin film transistors of the TFT substrate. Namely, the color filters and the thin film transistors have a self-aligned structure. Accordingly, an aperture ratio of the TFT-LCD panel is increased. In addition, the color filters may be exactly aligned with the thin film transistors on the TFT substrate.

Referring to FIG. 3, the TFT fingerprint identification substrate 400 is attached to the TFT-LCD panel having the color-filter-on-array structure.

The TFT fingerprint identification substrate 400 includes a first transparent substrate 412, a fingerprint identification thin film transistor 410, an inter-layer insulation film 440 and a common electrode 450. The first transparent substrate 412 comprises transparent material such as glass. The fingerprint identification thin film transistor 410 is formed on the first transparent substrate 412 and includes a sensor TFT for sensing a fingerprint pattern and a switch TFT. The inter-layer insulation film 440 is formed on the resultant structure. The common electrode 450 comprises transparent conductive material such as indium tin oxide (ITO) and is formed on a lower surface of the first transparent substrate 412.

In the TFT-LCD panel having the color-filter-on-array structure, red (R), green (G) and blue (B) color filters 336 instead of an insulation layer (for example, an organic insulating layer) is formed on the thin film transistors (not shown). In detail, the thin film transistors and data lines 334 electrically connected to the thin film transistors is formed on a second transparent substrate 330 comprised of a transparent material such as glass. Then, color filters 336 instead of the insulation layer are formed on the second transparent substrate on which the thin film transistors and data lines 334 are formed. A contact hole 345 is formed at the color filters so as to expose the data lines, and pixel electrodes 340 are formed on the resultant structure. However, an insulation layer 338 may be formed on the color filters having the contact holes 345, and then the pixel electrodes 340 may be formed on the an insulation layer 338.

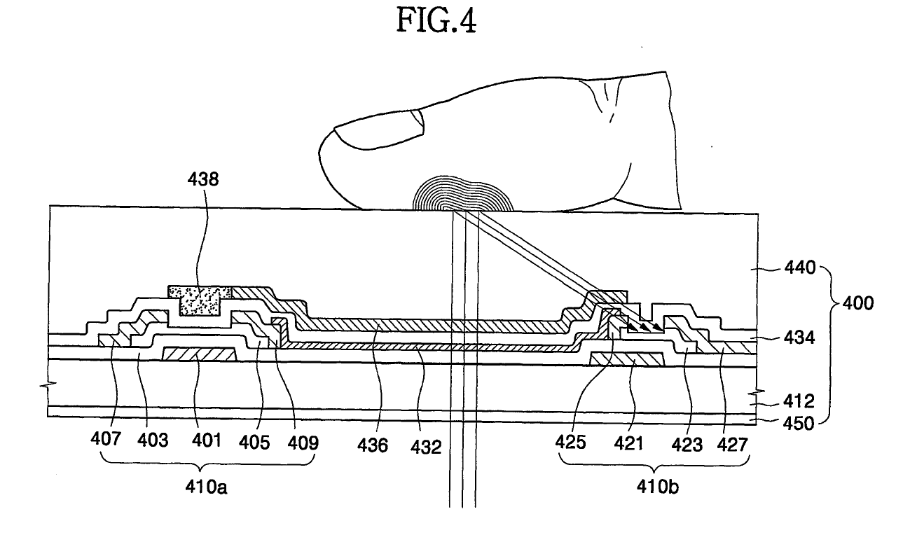

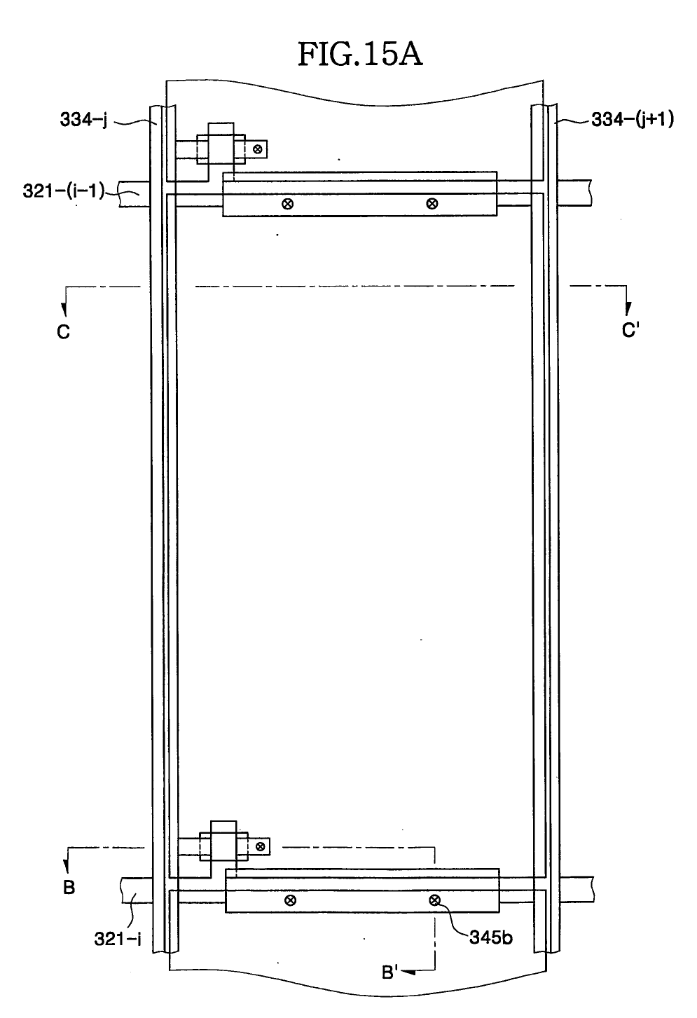

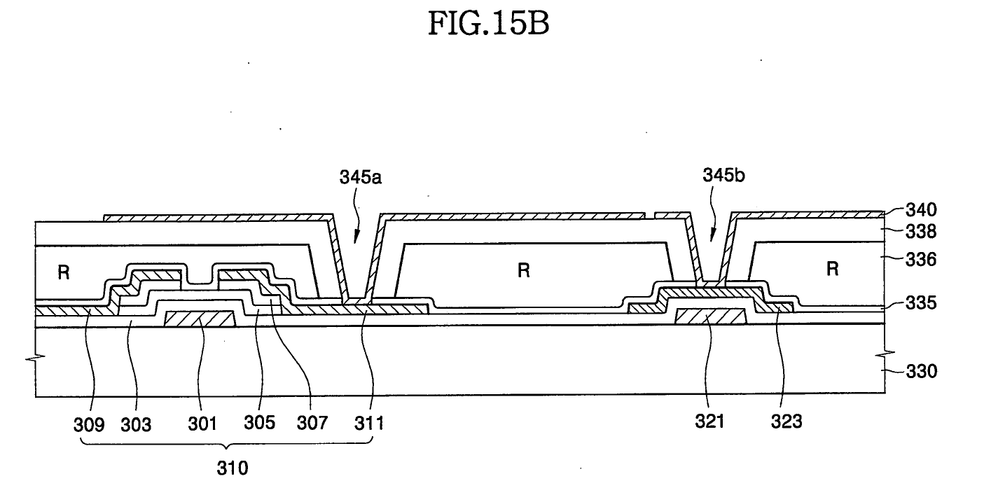

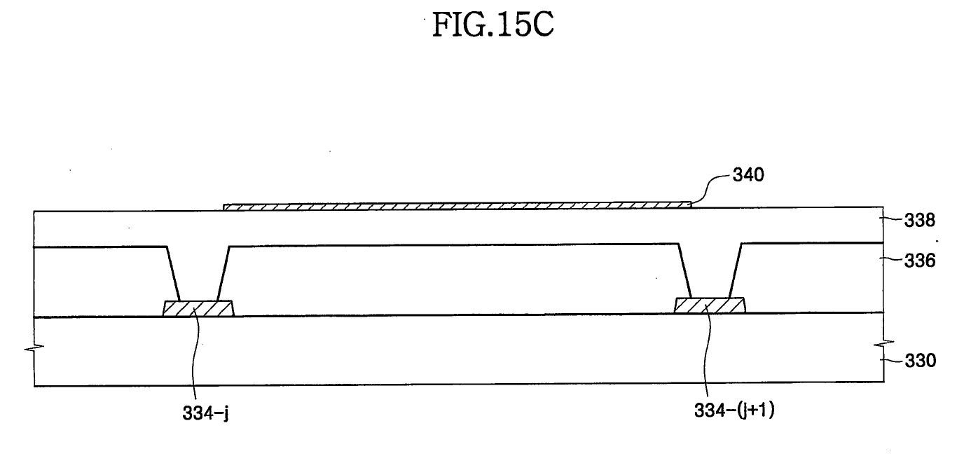

The thin film transistor is formed on the second transparent substrate 330 and includes a gate electrode, a gate insulation layer, a source electrode, a drain electrode, an active pattern and an ohmic contact pattern. (refer to FIGS. 4 and 15B)

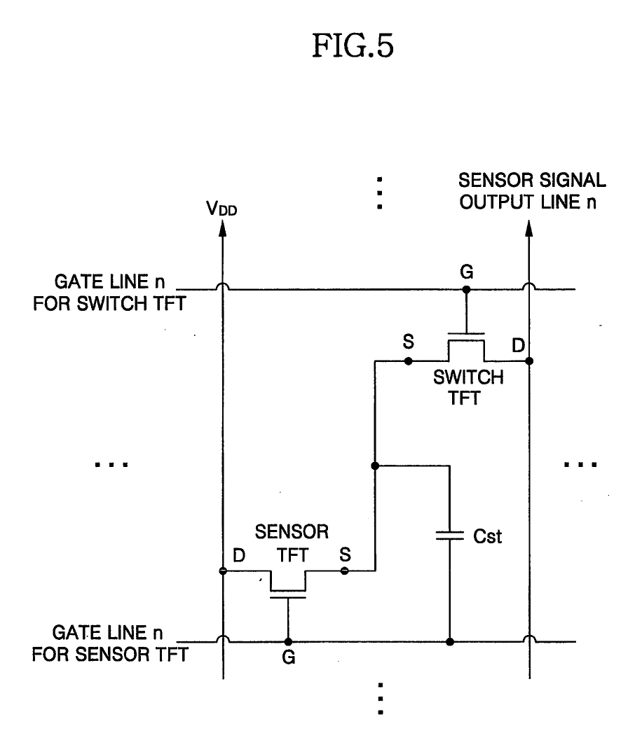

FIG. 4 is a cross-sectional view showing a unit cell of the TFT fingerprint identification substrate of FIG. 3, FIG. 5 is an equivalent circuit diagram showing a unit cell of the TFT fingerprint identification substrate of FIG. 4. Hereinafter, the principle of fingerprint identification is illustrated.

Referring to FIGS. 4 and 5, the TFT fingerprint identification substrate 400 includes the sensor TFT 410b, the switch TFT 410a and a storage capacitor (Cst), which are formed on the first transparent substrate 412.

A drain electrode 427 of the sensor TFT 410b is connected to an external power line V_{DD} (refer to FIG, 7), a source electrode 425 of the sensor TFT 410b and a source electrode 409 of the switch TFT 410a is connected with each other through a first electrode layer 432. A drain electrode 407 of the switch TFT 410a is connected to a sensor signal output line (refer to FIG. 5). A gate electrode 421 of the sensor TFT 410b is electrically connected to a gate line of the sensor TFT 410b, and a gate electrode 401 of the switch TFT 410a is electrically connected to a gate line of the switch TFT 410a. A second electrode layer 436 is electrically connected to the gate line of the sensor TFT (refer to FIG. 5). The gate line and data line may be comprised of ITO so as to reduce the decrease of aperture ratio due to the miss-alignment between the TFT fingerprint identification substrate 400 and the TFT substrate.

The second electrode layer 436 faces the first electrode layer 432, and the insulation layer 434 is disposed between the first and second electrode layers 432 and 436. The first and second electrode layers functions as a storage capacitor (Cst). The storage capacitor (Cst) accumulates electric charges proportional to the quantity of the light inputted into the sensor TFT 410b.

A channel region 423 is formed between the source electrode 425 and the drain electrode 427 of the sensor TFT 410b. The channel region 423 comprises amorphous silicon (a-Si). Accordingly, when the channel region 423 receives light more than a predetermined amount of light, the source electrode 425 is electrically conducted with the drain electrode 427.

When an user adhere his finger closely to the TFT fingerprint identification substrate 400, the light generated from the backlight assembly (not shown) disposed under the first transparent substrate 412 is incident into the TFT fingerprint identification substrate 400 through the liquid crystal layer 350. The light incident into the TFT fingerprint identification substrate 400 is reflected by ridges and valleys of the fingerprint and is incident into the channel region 423. Accordingly, the sensor TFT is electrically conducted, and the storage capacitor (Cst) accumulates the charges proportional to the quantity of light incident into the channel region 423.

A light shielding layer (or black matrix) 438 is formed over the drain electrode 407 and the source electrode 409 of the switching thin film transistor 410a. The light shielding layer 438 prevents the light from being incident into a channel region 405 of the switching thin film transistor 410a.

Hereinafter, the principle of fingerprint identification is illustrated with reference to FIG. 5.

A DC voltage (V_{DD}) having a predetermined voltage level is applied to the drain electrode (D) of the sensor thin film transistor 410b, and a bias voltage having a predetermined voltage level is applied to the gate electrode (G) of the sensor TFT 410b.

The gate electrode of the switching TFT 410a receives a gate driving signal from the gate driver part (not shown) and the switching TFT 410a is turned on or turn off in response to the gate driving signal. The gate driver part outputs the gate driving signal at every frame during which the fingerprint is scanned so as to turn on or turn off the switching TFT 410a, thereby outputting image frames for each of the sensor TFTs 410b. The image frame is formed using the fingerprint image inputted through the TFT fingerprint identification substrate 400.

In addition, the drain electrode (D) of the switching TFT 410a is connected to an amplifying circuit of an external data reading part through the sensor signal output line. When the switch TFT 410a is turned on, the voltage proportional to the quantity of the charges electrically charged in the storage capacitor (Cst) is outputted. A signal outputted from the source electrode (S) of the sensor TFT 41 0b is amplified through the amplifying circuit. Output terminals of the amplifying circuit are connected to a multiplexer and a single signal is outputted from the multiplexer.

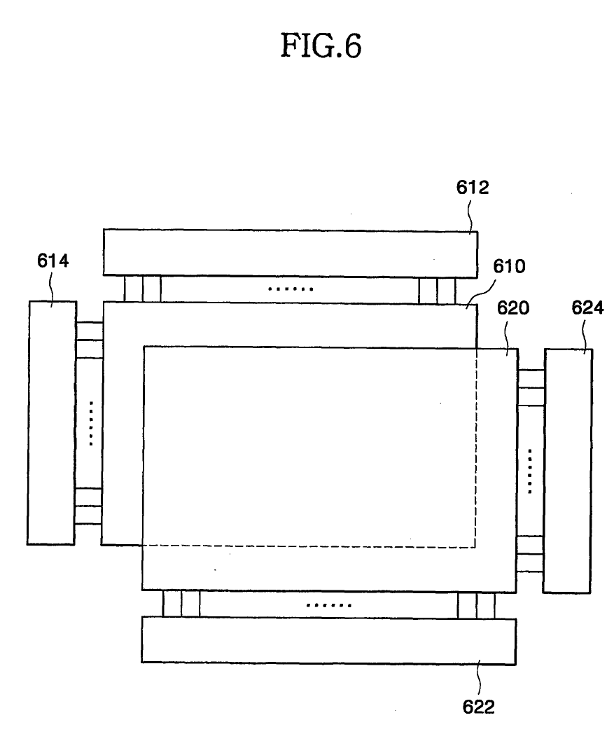

FIG. 6 is a schematic block diagram showing an arrangement between a TFT fingerprint identification substrate, a TFT substrate having a color-filter-on-array structure, a gate driver integrating circuit and a data driver integrating circuit according to one exemplary embodiment of the present invention. The gate driver part is integrated to be the gate driver integrating circuit, and the data driver part is integrated to be the data driver integrating circuit.

Referring to FIG. 6, a first data driver integrating circuit 612 may be disposed adjacent to an upper side face of the TFT-LCD substrate 610 to be connected to the upper side face of the TFT-LCD substrate 610. A first gate driver integrating circuit 614 may be disposed adjacent to a left side face of the TFT-LCD substrate 610 to be connected to the left side face of the TFT-LCD substrate 610. In addition, a second data driver integrating circuit 622 may be disposed adjacent to a lower side face of the TFT fingerprint identification substrate 620 to be connected to the lower side face of the TFT fingerprint identification substrate 620. A second gate driver integrating circuit 624 may be disposed adjacent to a right side face of the TFT fingerprint identification substrate 620 to be connected to the right side face of the TFT fingerprint identification substrate 620. The TFT fingerprint identification substrate 620 may be disposed over the TFT-LCD substrate 610.

When the TFT-LCD substrate 610 is attached to the TFT fingerprint identification substrate 620, the increase in the entire thickness of the TFT-LCD panel, which includes the TFT fingerprint identification substrate 620 having a gate driver integrating circuit and a data driver integrating circuit, should be prevented. Accordingly, the gate driver integrating circuits and data driver integrating circuits attached to the TFT-LCD substrate 610 and the TFT fingerprint identification substrate 620 are arranged not to be overlapped with each other. For example, when the first data driver integrating circuit 612 is disposed adjacent to an upper (or lower) side face of the TFT-LCD substrate 610, the second data driver integrating circuit 622 may be disposed adjacent to a lower (or upper) side face of the TFT fingerprint identification substrate 620. When a first gate driver integrating circuit 614 is disposed adjacent to a left (or right) side face of the TFT-LCD substrate 610, the second gate driver integrating circuit 624 may be disposed adjacent to a right (or left) side face of the TFT fingerprint identification substrate 620.

Hereinafter, a method of manufacturing a unit cell of TFT fingerprint identification substrate 400 is illustrated first, and then the method of manufacturing a pixel of TFT-LCD panel is illustrated.

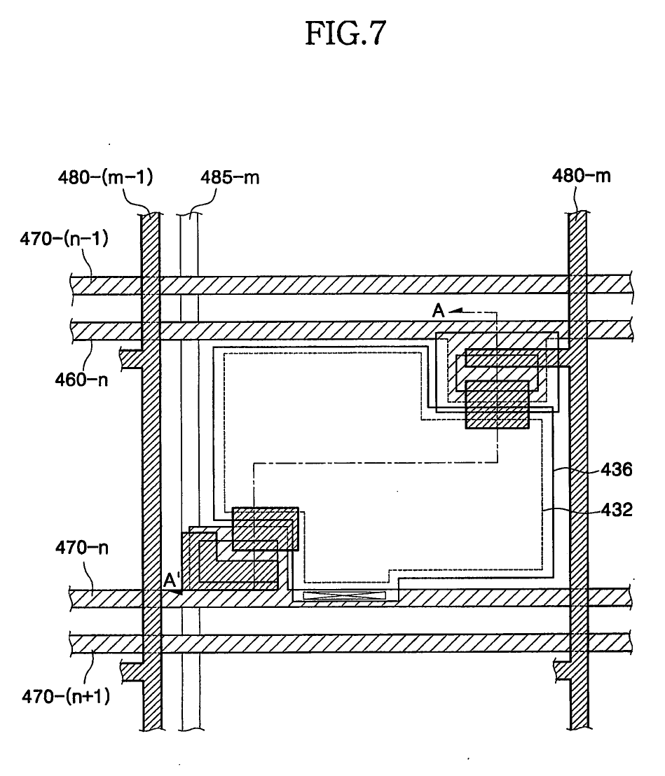

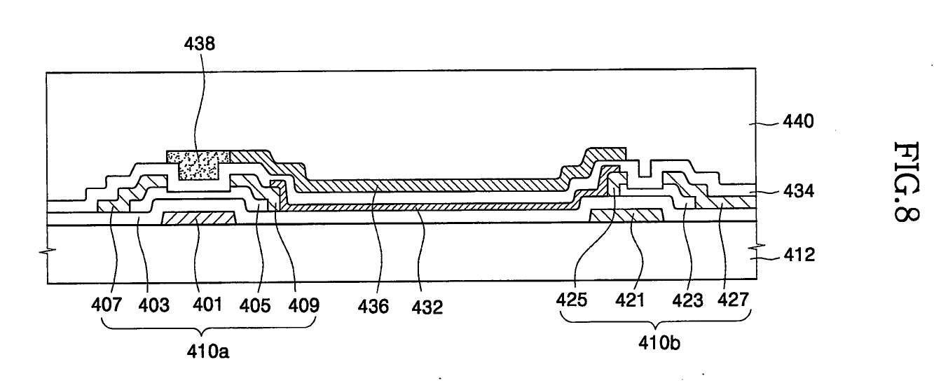

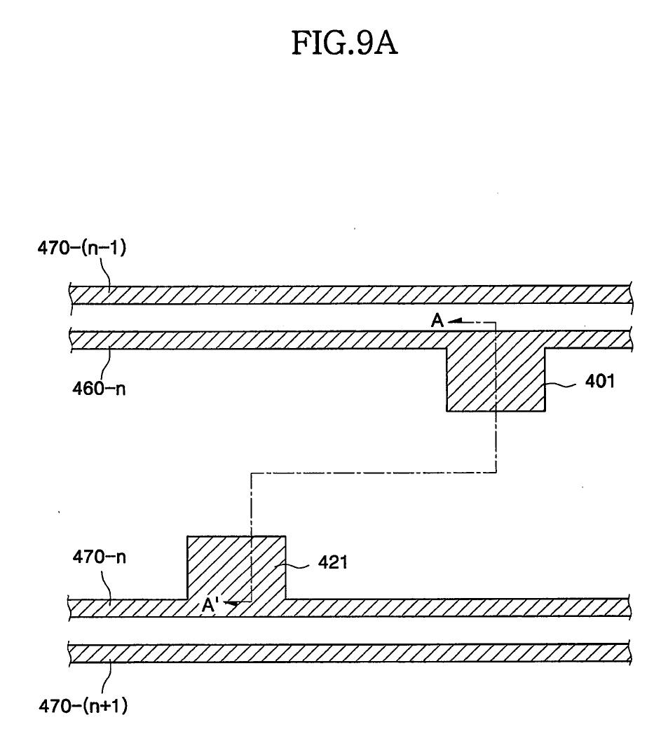

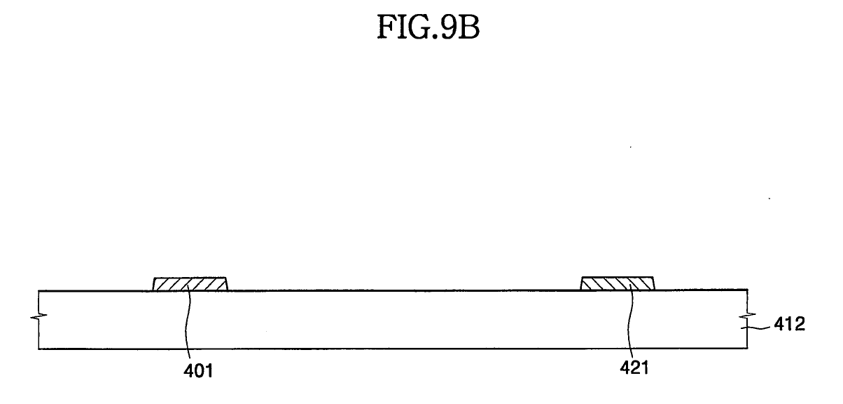

FIG. 7 is a plan view showing a unit cell of the TFT fingerprint identification substrate of FIG. 4, and FIG. 8 is a cross-sectional view taken along a line A-A′ of FIG. 7. FIGS. 9A to 14C are plan views and cross-sectional views illustrating a process of manufacturing a unit cell of the TFT fingerprint identification substrate of FIG. 7.

Referring to FIGS. 7 and 8, the unit cell of the TFT fingerprint identification substrate includes a sensor TFT 410b, a switch TFT 410a and a storage capacitor (Cst) having first and second electrode layer 432 and 436. The gate electrode 421 of the sensor TFT 410b and the gate electrode 401 of the switch TFT 410a may be portions or branches of a gate line 470-n of the sensor TFT 410b and a gate line 460-n of the switch TFT 410a, respectively. The second electrode layer 436 is connected to the gate line 470-n of the sensor TFT 410b.

Referring to FIGS. 9A and 9B, the gate electrode 421 of the sensor TFT 410b and the gate electrode 401 of the switch TFT 410a are formed on a first transparent substrate 412 comprised of glass, quartz or sapphire etc.

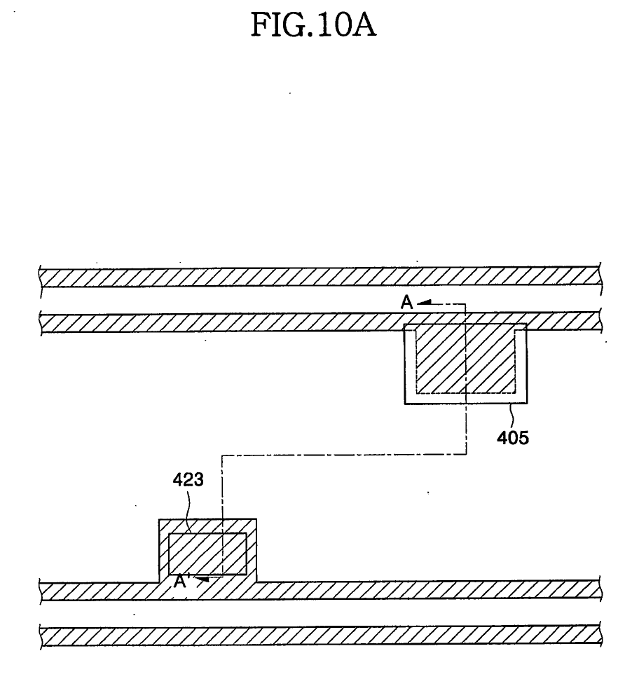

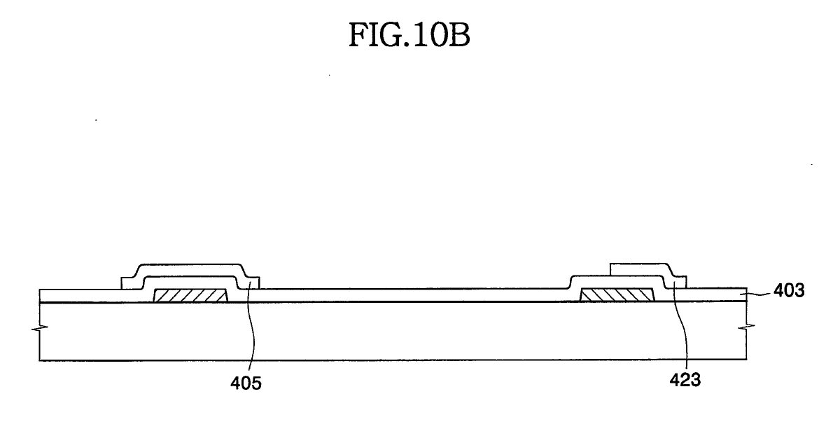

Referring to FIGS. 10A and 10B, a gate insulation layer comprised of SiNx is formed on the gate electrode 421 of the sensor TFT 410b and the gate electrode 401 of the switch TFT 410a. A channel region 423 of the sensor TFT 410b and a channel region 405 of the switch TFT 410a is formed on the gate insulation layer 403 by plasma enhanced chemical vapor deposition (PECVD). The channel regions 423 and 405 may be comprised of amorphous silicon (a-Si) and n⁺ amorphous silicon.

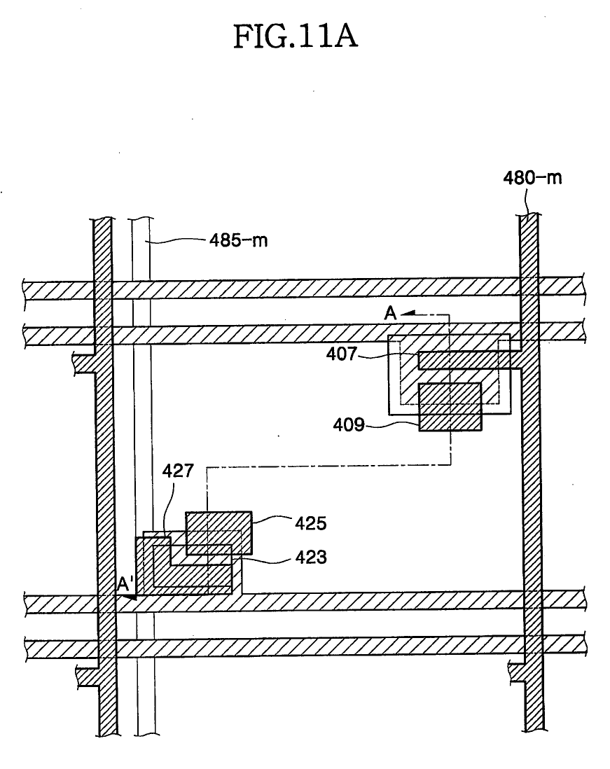

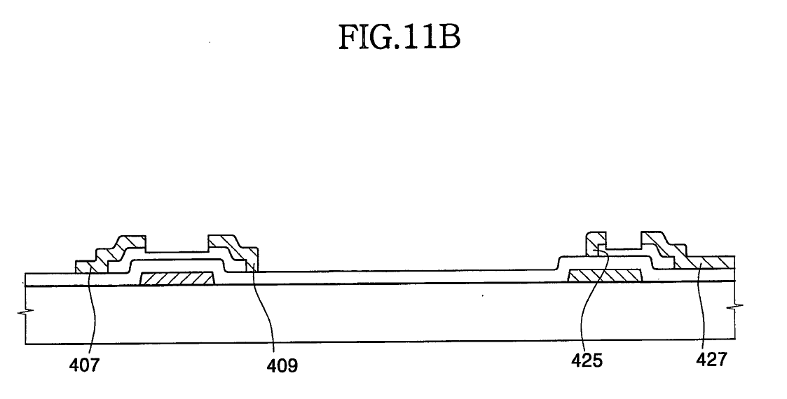

Referring to FIGS. 11A and 11B, data wirings comprised of metal layer is formed on the resultant structure. The data wirings includes the source electrode 425 of the sensor thin film transistor 410b, the drain electrode 427 of the sensor thin film transistor 410b, the source electrode 409 of the switch thin film transistor 410a, the drain electrode 407 of the switch thin film transistor 410a, the sensor signal output line 480-m and the external power line (V_{DD}) 485-m. The sensor signal output line 480-m intersects the gate lines 460-n and 470-n. For example, the gate lines 460-n and 470-n and the sensor signal output line 480-m comprises transparent electrode such as ITO.

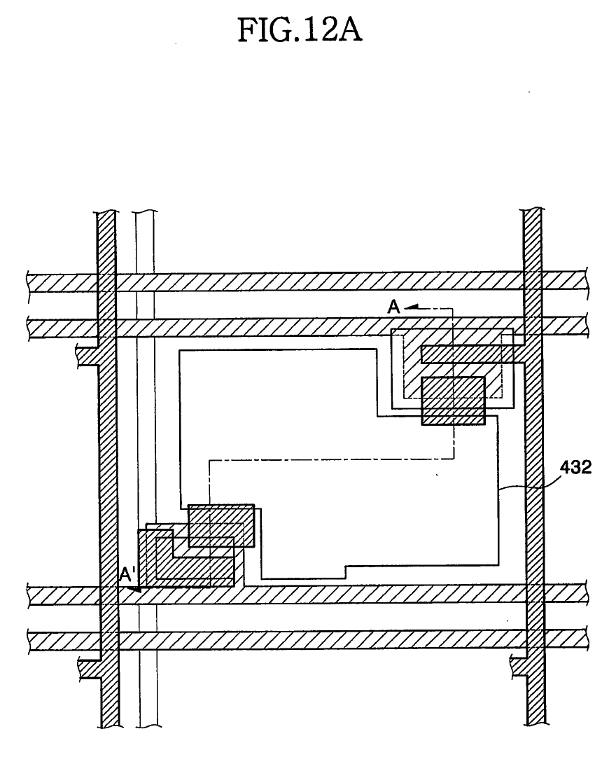

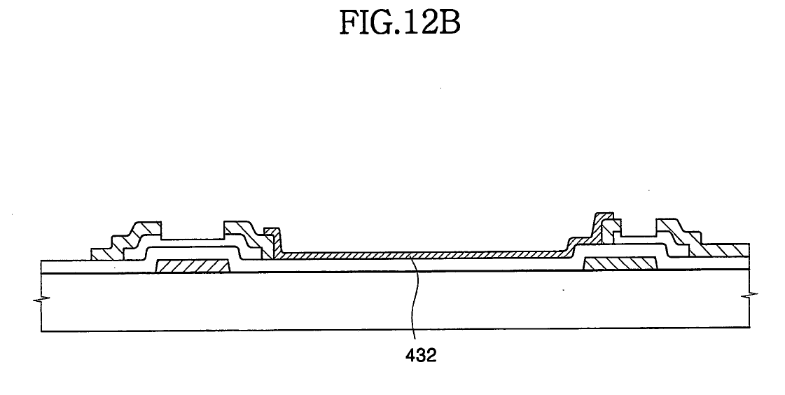

Referring to FIGS. 12A and 12B, the first electrode layer 432 comprised of ITO is formed on the resultant structure so as to form the storage capacitor (Cst).

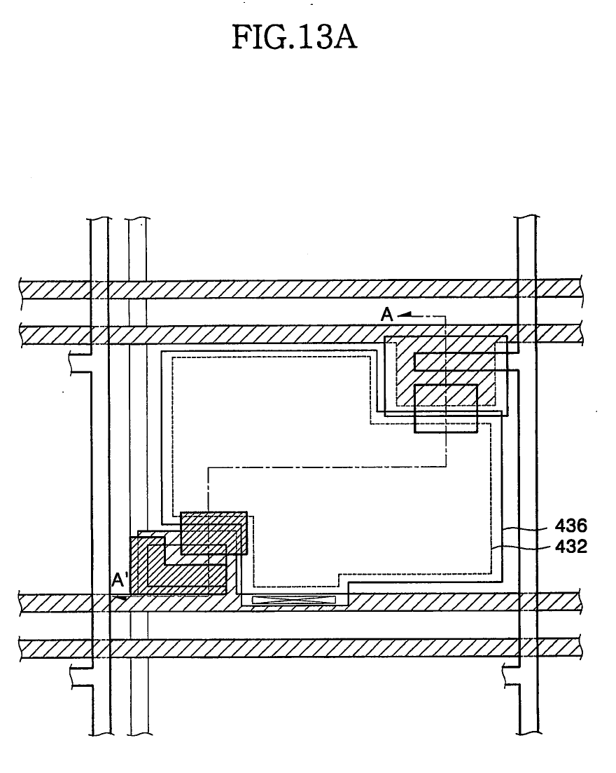

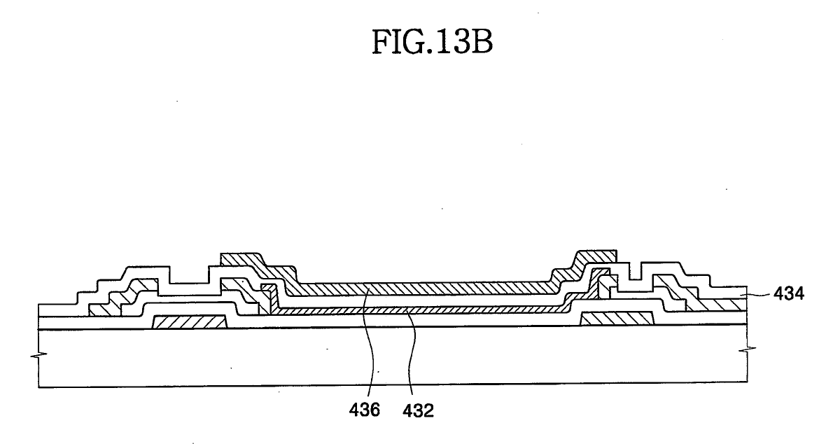

Referring to FIGS. 13A and 13B, the insulation layer 434 is formed on the data wirings and the first electrode layer 432. The second electrode layer 436 comprised of ITO is formed on the insulation layer to face the first electrode layer 432 such that the storage capacitor (Cst) is formed.

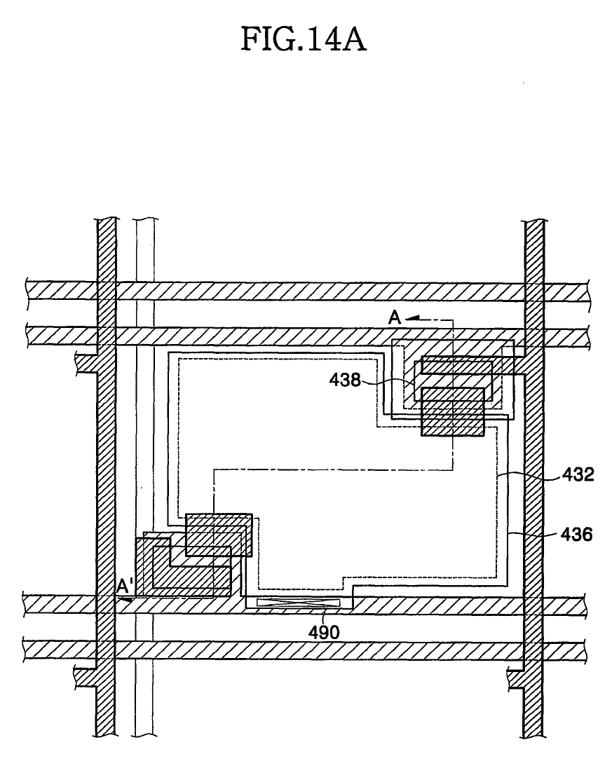

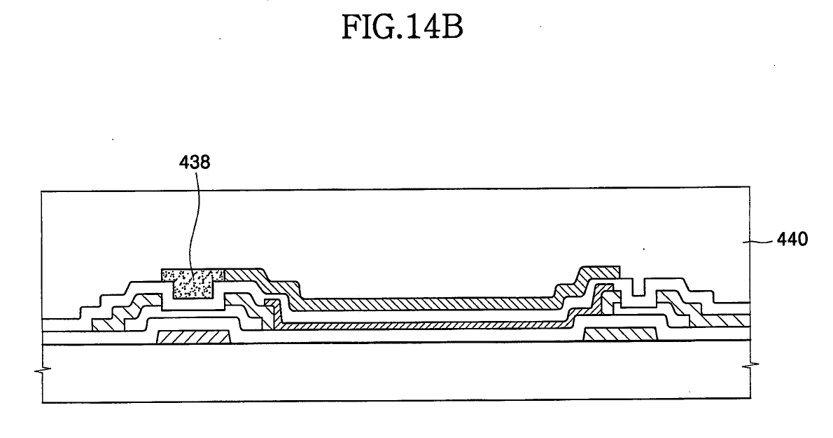

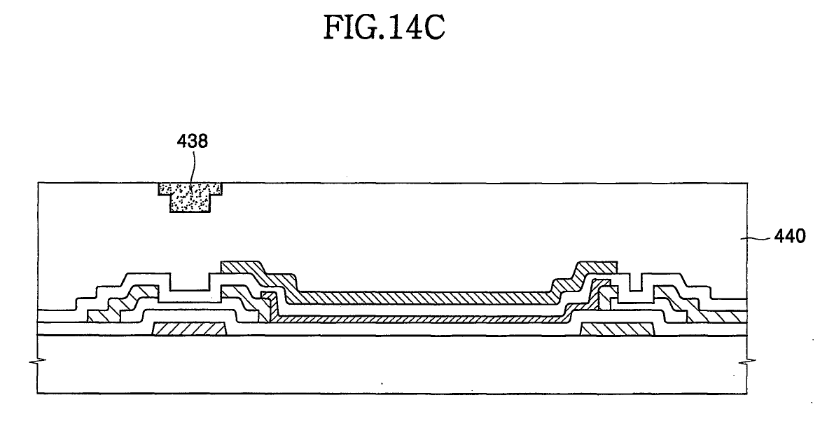

Referring to FIGS. 14A and 14B, the light shielding layer (or black matrix) 438 is formed on the insulation layer 434 to be disposed over the channel region 405. The light shielding layer 438 may be formed as the same layer as the second electrode layer 438. The light shielding layer 438 may be comprised of Cr/CrₓO_{y}. The inter-layer insulation film 440 is formed on the light shielding layer 438, the second electrode layer 436 and the insulation layer 434. The inter-layer insulation film 440 protects the light shielding layer 438, the second electrode layer 436 and the insulation layer 434 from external environment.

The light shielding layer 438 may not be formed as the same layer as the second electrode layer 438. Referring to FIG. 14C, after the inter-layer insulation layer 440 is formed, the light shielding layer 438 may be formed at a portion of the inter-layer insulation layer 440. The third portion is disposed over the channel region 405 of the switch thin film transistor 410a.

FIG. 15A is a plan view showing a pixel of the TFT fingerprint identification substrate of FIG. 3, FIG. 15B is a cross-sectional view taken along a line B-B′ of FIG. 15A, and FIG. 15C is a cross-sectional view taken along a line C-C′ of FIG. 15A.

Referring to FIGS. 15A, 15B and 15C, the TFT-LCD panel has a color-filter-on-array structure. In the color-filter-on-array structure, the color filters 336 are aligned with the thin film transistors 310 and the data lines 334-j and 334-(j+1). Namely, the color filters, the thin film transistors 310 and the data lines 334-j and 334-(j+1) have a self-aligned structure.

A pixel of TFT-LCD panel includes the thin film transistor 310, insulation layer 335, gate line 321-i, data line 334-j, color filter 340, organic insulating layer 338 and the pixel electrode 340. The gate line 321-i and data line 334-j is electrically connected with the thin film transistor 310.

In the TFT-LCD panel having the color-filter-on-array structure, photosensitive red (R), green (G) and blue (B) color filters 336 instead of the insulation layer (or organic insulating layer) is formed on the thin film transistor 310. Namely, the switch thin film transistor 310 is formed on the second transparent substrate 330 comprised of glass, and the color filters 336 is formed on the second transparent substrate 330 on which the switch thin film transistor 310 is formed. Then, a first contact hole is formed at the color filters to expose a first portion of the drain electrode 311.

The organic insulating layer 338 having a second contact hole is formed on the entire surface of the resultant structure including the first contact hole. The second contact hole exposes a second portion of the drain electrode 311 of the switch thin film transistor 310. The second portion of the drain electrode 311 is disposed over the first portion of the drain electrode 311 to correspond to the first portion of the drain electrode 311.

The pixel electrode 340 having a third contact hole is formed on the entire surface of the resultant structure including the second contact hole. The third contact hole exposes a third portion of the drain electrode 311 of the switch thin film transistor 310 to make electrical contact with the drain electrode 311. The third portion of the drain electrode 311 is disposed over the second portion of the drain electrode 311 to correspond to the second portion of the drain electrode 311.

However, the organic insulating layer may not be formed. Namely, after the color filters 336 is formed on the second transparent substrate 330 on which the switch thin film transistor 310 is formed, the pixel electrode 340 instead of the organic insulating layer may be formed on the entire surface of the resultant structure including the first contact hole.

The switch thin film transistor 310 includes a gate electrode 301, a gate insulation layer 303, an active pattern 305, an ohmic contact pattern 307, a source electrode 309 and a drain electrode 311. The gate electrode 301, gate insulation layer 303, active pattern 305, ohmic contact pattern 307, source electrode and drain electrodes 311 are formed on the second transparent substrate 330 comprised of glass.

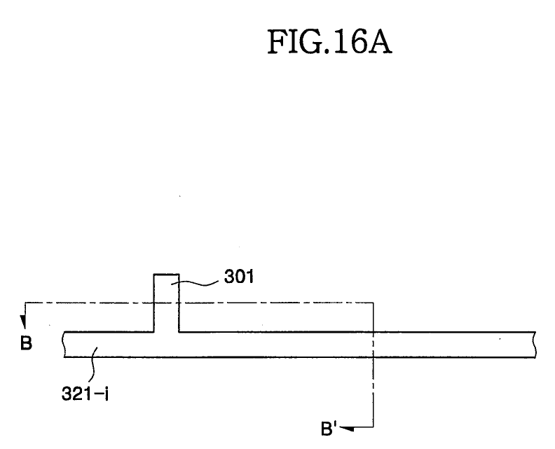

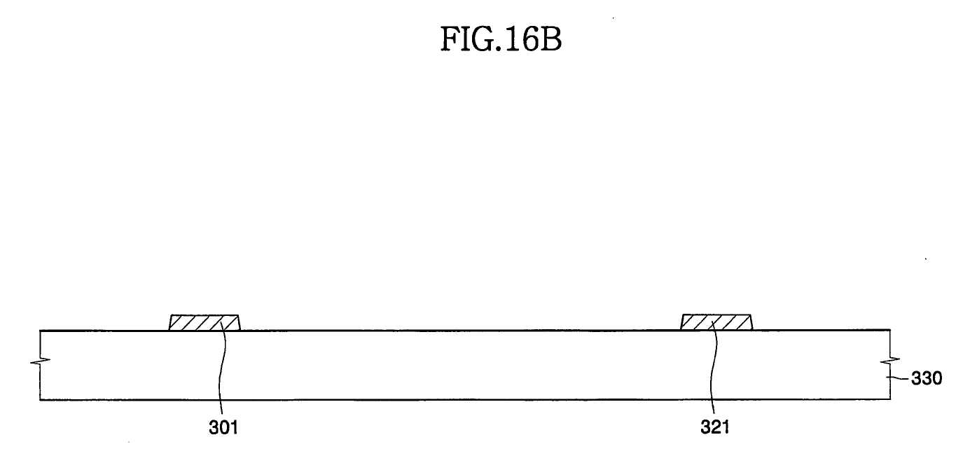

FIGS. 16A to 20C are plan views and cross-sectional views illustrating a process of manufacturing a pixel of the TFT fingerprint identification substrate of FIG. 15A.

Referring to FIGS. 16A and 16B, a first metal layer comprised of Al—Nd or Al—Nd/Cr is deposited by sputtering method on the second transparent substrate 330. The first metal layer is patterned by a photolithography process using a first mask to form the gate line 321 and the gate electrode 301 branched from the gate line 321.

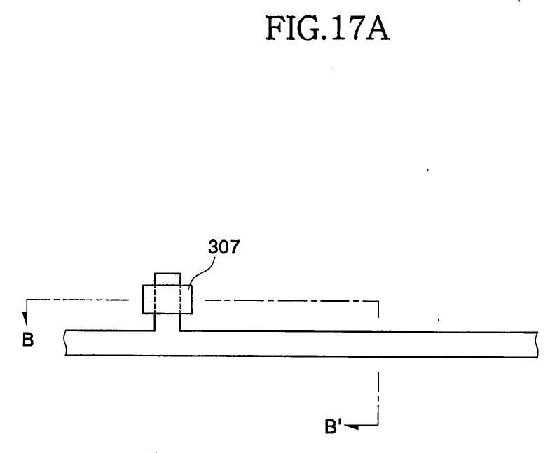

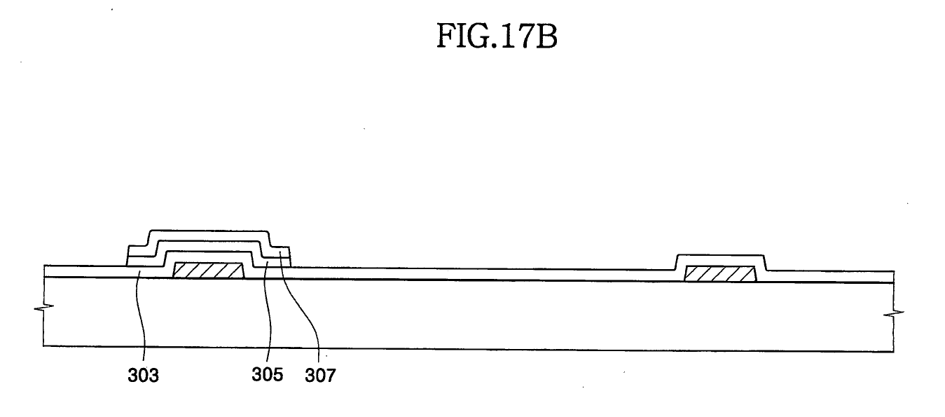

Referring to FIGS. 17A and 17B, the gate insulation layer 303 comprised of silicon nitride is formed on the entire surface of the second transparent substrate 330 on which the gate line 321 and the gate electrode 301 is formed. The active pattern 305 and the ohmic contact pattern 307 is formed on the gate insulation layer 303 using a second mask to be disposed over the gate electrode 301. The active pattern 305 is composed of amorphous silicon and the ohmic contact pattern 307 is comprised of n⁺ doped amorphous silicon.

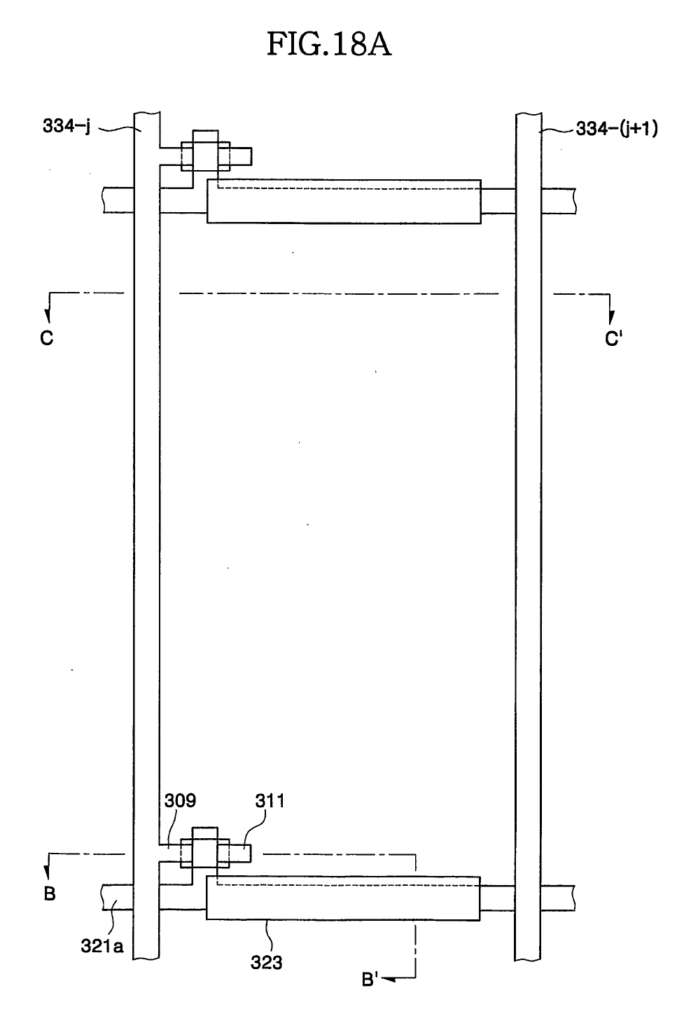

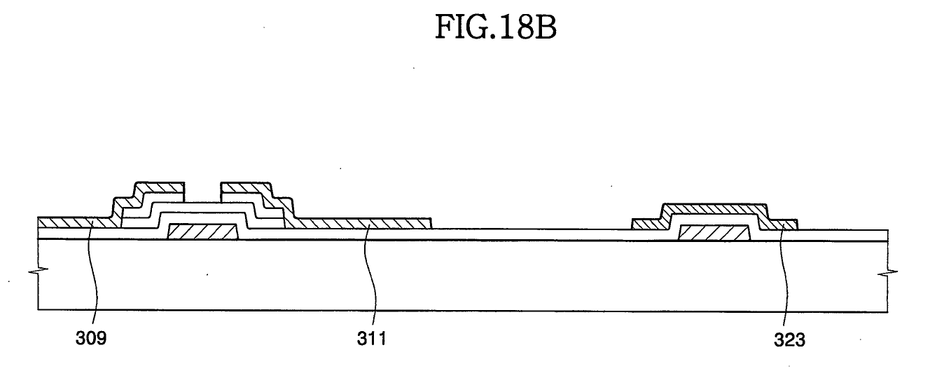

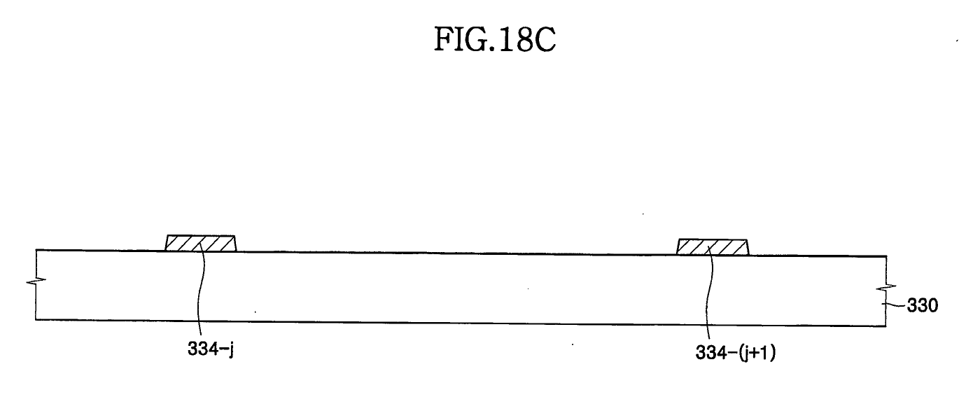

Referring to FIGS. 18A, 18B and 18C, a second metal layer comprised of metal such as Cr is deposited on the ohmic contact pattern 307 and gate insulation layer 303 by a sputtering method. The second metal layer is patterned by photolithography process using a third mask to form the data wirings. The data wirings includes the drain electrode 311 of the switch thin film transistor 410a, the source electrode 309 of the switch thin film transistor 410a, the second electrode layer 323, the data lines 334-j and 334(j+1) and data pad (not shown). The second electrode layer 323 is referred to as a storage electrode and functions as a storage capacitor (Cst) together with the gate lines.

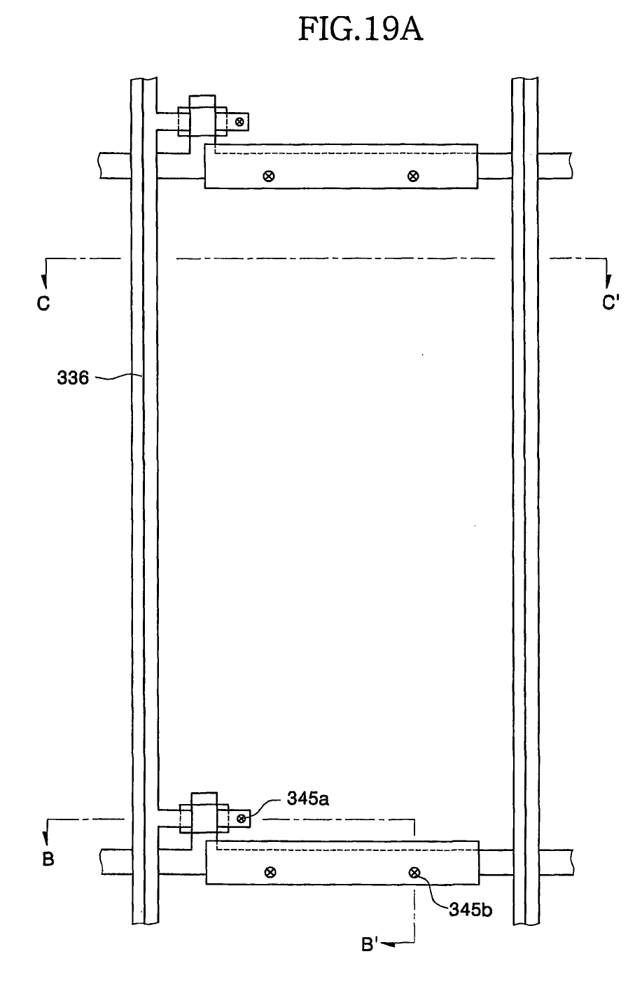

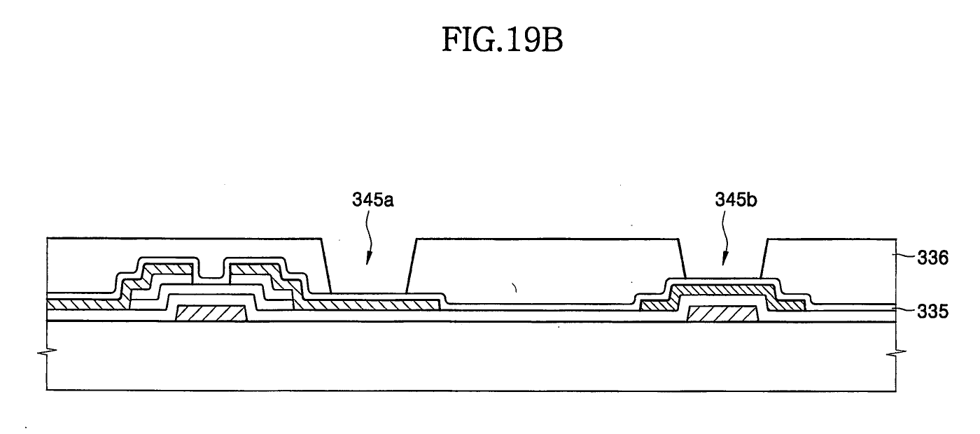

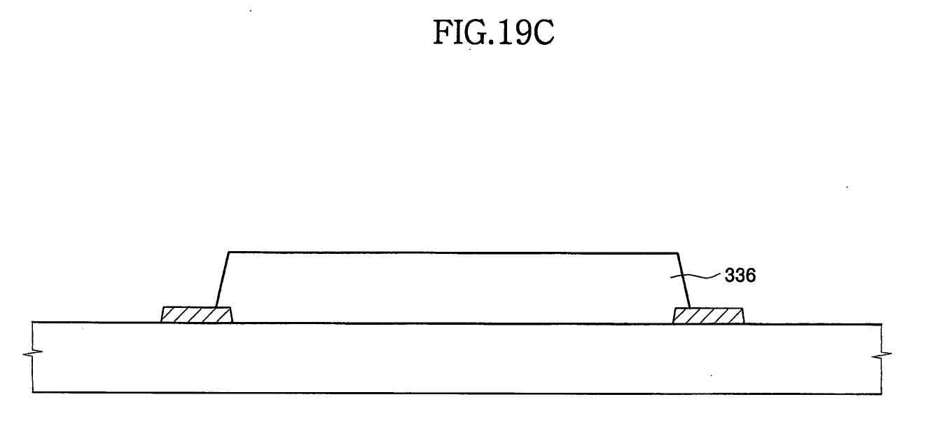

Referring to FIGS. 19A, 19B and 19C, the ohmic contact pattern 307 is removed by a reactive ion etching using a fourth mask such that the channel region of the switch thin film transistor 410a is formed over the gate electrode 301. Subsequently, the insulation layer 335 comprised of silicon nitride is deposited on the entire surface of the resultant structure. After the red (R), green (G) and blue (B) color filters 336 is formed on the insulation layer 335, the color filters 336 is patterned by a photolithography process using a fifth mask such that the contact holes 345a and 345b are formed on the color filters 336.

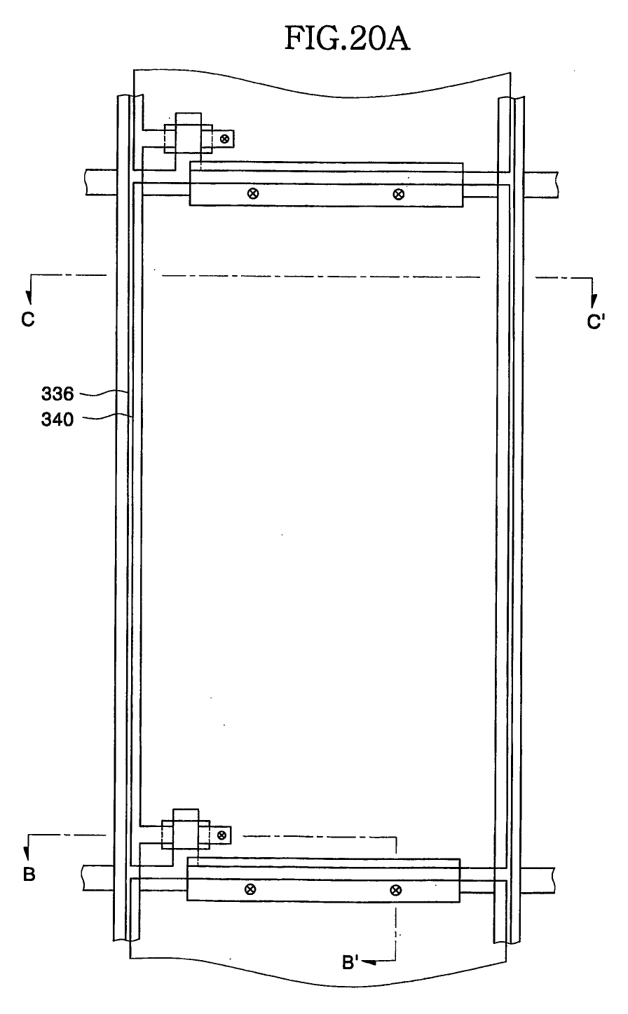

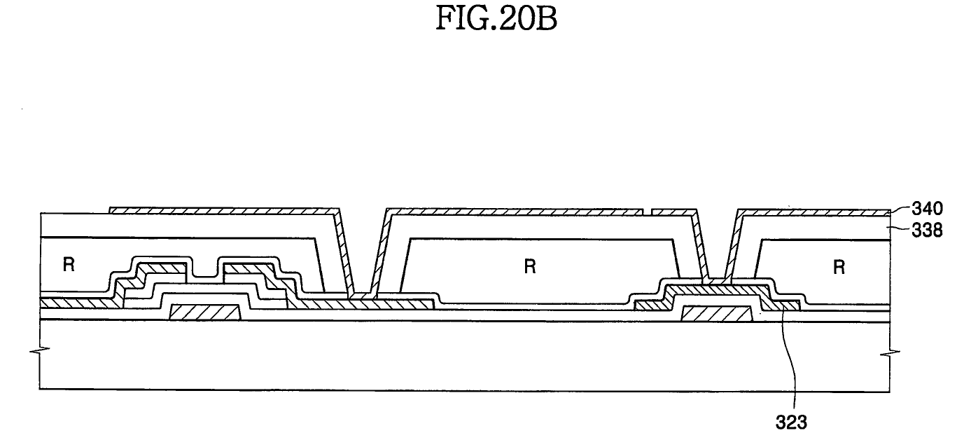

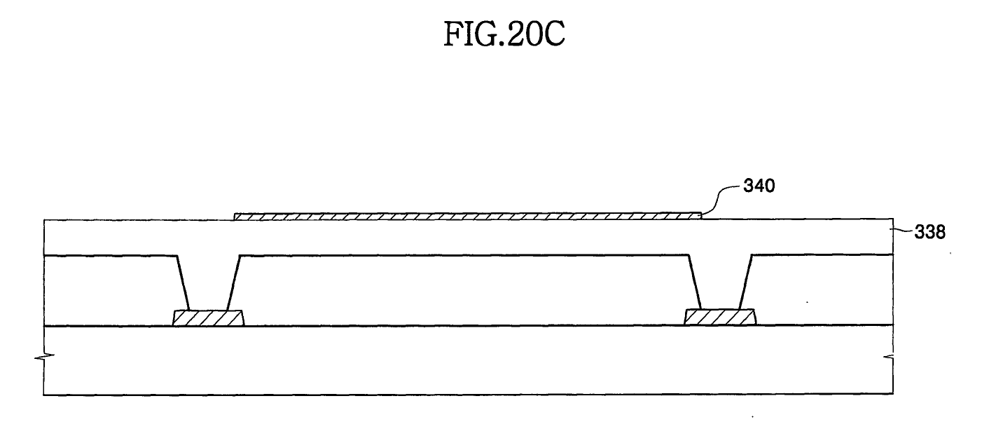

Referring to FIGS. 20A, 20B and 20C, the organic insulating layer 338 comprised of acrylic resin is formed on the entire surface of the resultant structure, and then the organic insulating layer 338 is patterned by a photolithography process using a sixth mask. The pixel electrode 340 comprised of ITO is patterned by photolithography process using a seventh mask on the entire surface of the resultant structure. The pixel electrode 340 is electrically connected with a third electrode 323.

In the structure of the TFT substrate of the TFT-LCD panel mounted with the TFT fingerprint identification substrate according to one exemplary embodiment of the present invention, the color filter layer may be formed on the thin film transistor, or the thin film transistor may be formed on the color filter layer.

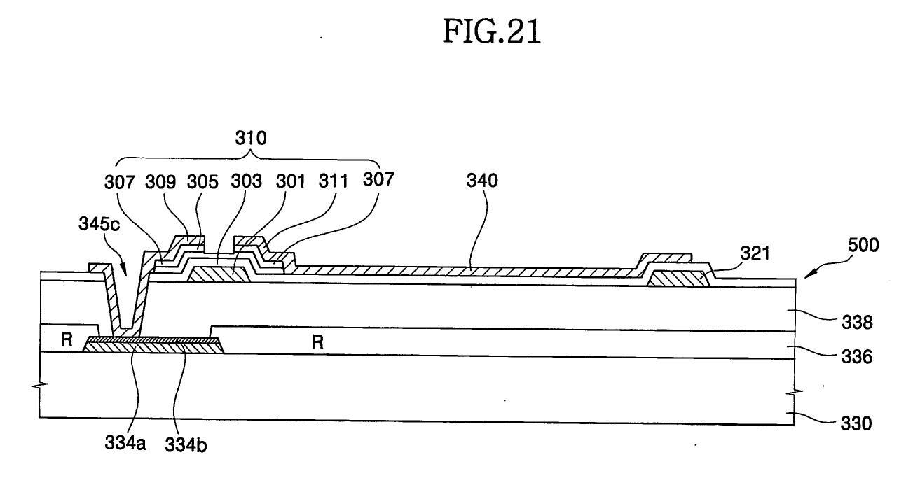

FIG. 21 is a cross-sectional view showing a pixel of the TFT-LCD panel mounted with a TFT fingerprint identification substrate of FIG. 3 according to another exemplary embodiment of the present invention;

Referring to FIG. 21, a TFT substrate 500 includes a lower transparent substrate 330, a data wiring, a color filter layer 336, an insulation layer 338, a gate wiring, a thin film transistor 310 and a pixel electrode 340.

The data wiring is formed on the lower transparent substrate 330 comprised of a transparent material such as glass and includes a data line 334a and 334b and a data pad (not shown). The data line, as shown in FIG. 21, may include a double layer having an upper film 334a and a lower film 334b, or may include a single layer comprised of a conductive material. For example, the upper film 334a comprises a material easily forming junction with other material. For example, the upper film 334a comprises chrome (Cr). For example, the lower film 334b comprises a material having a low resistance such as aluminum (Al), aluminum alloy or copper (Cu). A portion of the data line may function as a light shielding layer (or black matrix) for blocking the light incident from the lower surface of the lower transparent substrate 330.

The color filter 336 is formed on the lower transparent substrate 330 on which the data wiring is formed. The color filter 336 includes red (R), green (G) and blue (B) color filters. A peripheral portion of the color filter layer 336 covers the data line 334a and 334b and the data pad.

The insulation layer 338 is formed on the color filter layer 336 and may include organic insulation layer.

The gate wiring is formed on the insulation layer 338 and includes a gate line 321 and a gate pad (not shown).

The thin film transistor 310 includes a gate electrode 301, a gate insulation layer 303, an active pattern 305, an ohmic contact pattern 307, a source electrode 309 and a drain electrode 311.

The pixel electrode 340 comprises a transparent conductive material such as ITO or IZO. The pixel electrode is electrically connected to the drain electrode 311 of the thin film transistor 310.

A contact hole 345c is formed on the source electrode 309 and the source electrode 309 is electrically connected to the data line 334a and 334b.

According to above embodiment of the present invention, since the gate line 321 and the data line 334a and 334b function as the light shielding layer, a light shielding layer may not be formed on a upper transparent substrate (not shown) disposed on the liquid crystal layer (not shown) interposed between the upper and lower transparent substrates. Therefore, the miss-alignment between the upper and lower transparent substrates may be reduced, the aperture ratio of the TFT-LCD panel may be increased, and the quality of image display may be enhanced.

The structure of the TFT fingerprint identification substrate disposed over the TFT substrate is the same or similar to that of the TFT fingerprint identification substrate according to above described embodiments.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A liquid crystal display device comprising:
a first substrate including a plurality of unit cells, each of the unit cells having i) a sensor thin film transistor for receiving a light reflected from a fingerprint to generate electric charges corresponding to an intensity of the reflected light, ii) a storage device for storing the electric charges, iii) a first switch thin film transistor for receiving the electric charges from the storage device to output the electric charges in response to an external control signal;
a first transparent electrode disposed on a lower surface of the first substrate;
a second substrate including a pixel, the pixel having i) a second switch thin film transistor, ii) a data line electrically coupled with a first electrode of the second switch thin film transistor, iii) a gate line electrically coupled with a second electrode of the second switch thin film transistor, iv) a color filter layer formed on first portions of the gate line, the data line and the second switch thin film transistor, v) a second transparent electrode formed on the color filter layer and electrically coupled with a second portion of the first electrode; and
a liquid crystal layer interposed between the first and second substrates.

2. The liquid crystal display device of claim 1, wherein the second substrate further comprises a first insulation layer disposed between the color filter layer and the second transparent electrode to cover the color filter layer, the first insulation layer electrically coupled with the second portion of the first electrode.

3. The liquid crystal display device of claim 1, wherein at least two unit cells is arranged over one pixel.

4. The liquid crystal display device of claim 3, three unit cells are arranged over the pixel having a first aspect ratio of 1:3, each of the unit cells having a second aspect ratio of 1:1.

5. The liquid crystal display device of claim 4, wherein the first substrate further comprises a sensor signal output line for outputting a sensing signal, the sensor signal output line connected with the sensor thin film transistor, the gate line and a third electrode of the sensor thin film transistor, and the sensor signal output line comprised of transparent conductive material.

6. The liquid crystal display device of claim 1, wherein the first substrate further comprises a second insulation layer covering the sensor thin film transistor, the storage device and the first switch thin film transistor.

7. The liquid crystal display device of claim 6, wherein the first switching thin film transistor comprises:
a channel region comprised of amorphous silicon; and
a light shielding layer, disposed on a third portion of the second insulation layer, for shielding the channel region from the light reflected from the fingerprint, the third portion disposed over the channel region, and the light shielding layer comprised of Cr/Cr_{X}O_{Y}.

8. The liquid crystal display device of claim 6, wherein the first switching thin film transistor comprises:
a channel region comprised of amorphous silicon; and
a light shielding layer, disposed over the channel region, for shielding the channel region from the light reflected from the fingerprint, and the light shielding layer comprised of Cr/Cr_{X}O_{Y}.

9. The liquid crystal display device of claim 1, wherein the liquid crystal display device further comprises:
a data reading part, disposed adjacent to a first side face of the first substrate to be connected to the first side face of the first substrate, for receiving the charges from a first electrode of the first switch thin film transistor to generate a fingerprint identification signal corresponding to the fingerprint;
a first gate driver part, disposed adjacent to a second side face of the first substrate to be connected to the second side face of the first substrate, for turning on or turning off a second electrode of the first switch thin film transistor and a second electrode of the sensor thin film transistor;
a data driver part, disposed adjacent to a first side face of the second substrate to be connected to the first side face of the second substrate, for applying an image data signal to a third electrode of the second thin film transistor through the data line; and
a second gate driver part, disposed adjacent to a second side face of the second substrate to be connected to the second side face of the second substrate, for turning on or turning off the second electrode of the second switch thin film transistor, wherein the data driver part is opposite to the data reading part and the first gate driver part is opposite to the second gate driver part.

10. A method of manufacturing a liquid crystal display device, the method comprising:
forming a sensor thin film transistor, a storage device and a first switch thin film transistor and on a first substrate comprised of insulation material, the sensor thin film transistor receiving a light reflected from a fingerprint to generate electric charges corresponding to an intensity of the reflected light, the storage device storing the electric charges, and the first switch thin film transistor receiving the electric charges from the storage device to output the electric charges in response to an external control signal;
forming a first transparent electrode on a lower surface of the first substrate;
forming a second switch thin film transistor, a data line and a data line on a second substrate comprised of insulation material, the data line electrically coupled with a first electrode of the second switch thin film transistor, and the gate line electrically coupled with a second electrode of the second switch thin film transistor,
forming a color filter layer on first portions of the gate line, the data line and the second switch thin film transistor;
forming a second transparent electrode on the color filter layer, the second transparent electrode electrically coupled with a second portion of the first electrode of the second switch thin film transistor; and
forming a liquid crystal layer between the first and second substrates.

11. The method of manufacturing the liquid crystal display device of claim 10, wherein the method further comprises forming a first insulation layer between the color filter layer and the second transparent electrode to cover the color filter layer, the first insulation layer electrically coupled with the second portion of the first electrode.

12. The method of manufacturing the liquid crystal display device of claim 10, wherein the method further comprises forming a second insulation layer on the sensor thin film transistor, the storage device and the first switch thin film transistor, the second insulation layer covering the sensor thin film transistor, the storage device and the first switch thin film transistor.

13. The method of manufacturing the liquid crystal display device of claim .12, wherein the method further comprises:
forming a channel region comprised of amorphous silicon; and
forming a light shielding layer at a third portion of the second insulation layer, the third portion disposed over the channel region, the light shielding layer shielding the channel region from the light reflected from the fingerprint, and the light shielding layer comprised of Cr/Cr_{X}O_{Y}.

14. The method of manufacturing the liquid crystal display device of claim 13, wherein the method further comprises:
forming a channel region comprised of amorphous silicon; and
forming a light shielding layer, disposed over the channel region, for shielding the channel region from the light reflected from the fingerprint, and the light shielding layer comprised of Cr/Cr_{X}O_{Y}.

15. A method of manufacturing the liquid crystal display device, the method comprising:
forming a sensor thin film transistor, a storage device and a first switch thin film transistor and on a first substrate comprised of insulation material, the sensor thin film transistor receiving a light reflected from a fingerprint to generate electric charges corresponding to an intensity of the reflected light, the storage device storing the electric charges, and the first switch thin film transistor receiving the electric charges from the storage device to output the electric charges in response to an external control signal;
forming a first transparent electrode on a lower surface of the first substrate;
forming a second switch thin film transistor on a second substrate comprised of insulation material;
forming a color filter layer on the second switch thin film transistor;
forming a second transparent electrode on the color filter layer;
aligning the first substrate over the second substrate base on a first aspect ration for a first pixel unit of the first substrate and a second aspect ration for a second pixel unit of the second substrate; and
forming a liquid crystal layer between the first and second substrates.

16. The method of manufacturing the liquid crystal display device of claim 15, wherein the method further comprises forming a first contact hole on the color filter, the first contact hole exposing a first portion of a first electrode of the second switch thin film transistor.

17. The method of manufacturing the liquid crystal display device of claim 16, wherein the method further comprises forming a second contact hole on the second transparent electrode, the second contact hole exposing a second portion of the first electrode of the second switch thin film transistor, the second portion corresponding to the first portion of the first electrode of the second switch thin film transistor.

18. The method of manufacturing the liquid crystal display device of claim 17, wherein the method further comprises forming a first insulation layer between the color filter layer and the second transparent electrode to cover the color filter layer, the first insulation layer having a third contact hole that exposes the second portion of the first electrode of the second switch thin film transistor.

19. The method of manufacturing a liquid crystal display device of claim 18, wherein the method further comprises forming a second insulation layer on the sensor thin film transistor, the storage device and the first switch thin film transistor, the second insulation layer covering the sensor thin film transistor, the storage device and the first switch thin film transistor.

20. The method of manufacturing a liquid crystal display device of claim 19, wherein the method further comprises:
forming a channel region comprised of amorphous silicon; and
forming a light shielding layer at a third portion of the second insulation layer, the third portion disposed over the channel region, the light shielding layer shielding the channel region from the light reflected from the fingerprint, and the light shielding layer comprised of Cr/Cr_{X}O_{Y}.

21. The method of manufacturing a liquid crystal display device of claim 15, wherein the method further comprises:
forming a channel region comprised of amorphous silicon; and
forming a light shielding layer, disposed over the channel region, for shielding the channel region from the light reflected from the fingerprint, and the light shielding layer comprised of Cr/Cr_{X}O_{Y}.

22. The method of manufacturing a liquid crystal display device of claim 15, wherein the method further comprises:
connecting a data reading part to a first side face of the first substrate, the data reading part being disposed adjacent to the first side face of the first substrate and receiving the charges from a first electrode of the first switch thin film transistor to generate a fingerprint identification signal corresponding to the fingerprint;
connecting a first gate driver part to a second side face of the first substrate, the first gate driver part being disposed adjacent to the second side face of the first substrate and turning on or turning off a second electrode of the first switch thin film transistor and a second electrode of the sensor thin film transistor;
connecting a data driver part to a first side face of the second substrate, the data driver part being disposed adjacent to the first side face of the second substrate and applying an image data signal to a third electrode of the second thin film transistor through the data line; and
connecting a second gate driver part to a second side face of the second substrate, the second gate driver part being disposed adjacent to the second side face of the second substrate and turning on or turning off the second electrode of the second switch thin film transistor, wherein the data driver part is opposite to the data reading part and the first gate driver part is opposite to the second gate driver part.

23. A liquid crystal display device comprising:
a first substrate including a plurality of unit cells, each of the unit cells having i) a sensor thin film transistor for receiving a light reflected from a fingerprint to generate electric charges corresponding to an intensity of the reflected light, ii) a storage device for storing the electric charges, iii) a first switch thin film transistor for receiving the electric charges from the storage device to output the electric charges in response to an external control signal;
a first transparent electrode disposed on a lower surface of the first substrate;
a second substrate;
a pixel including i) a data wiring having a data line formed in the second substrate, ii) a color filter layer on the second substrate on which the data wiring is formed, the color filter layer covering a first portion of the data wiring, iii) an insulation layer covering the data wiring and the color filter layer, iv) a second switch thin film transistor formed on the insulation layer, and v) a second transparent electrode electrically coupled with a second portion of a first electrode of the second switch thin film transistor; and
a liquid crystal layer interposed between the first and second substrates.

24. The liquid crystal display device of claim 23, three unit cells are arranged over the pixel having a first aspect ratio of 1:3, each of the unit cells having a second aspect ratio of 1:1.

25. The liquid crystal display device of claim 24, wherein the first substrate further comprises a sensor signal output line for outputting a sensing signal, the sensor signal output line being connected to the sensor thin film transistor, the gate line and a third electrode of the sensor thin film transistor, and the sensor signal output line being comprised of transparent conductive material.

26. The liquid crystal display device of claim 23, wherein the first substrate further comprises a second insulation layer covering the sensor thin film transistor, the storage device and the first switch thin film transistor.

27. The liquid crystal display device of claim 26, wherein the first switching thin film transistor comprises:
a channel region comprised of amorphous silicon; and
a light shielding layer, disposed on a third portion of the second insulation layer, for shielding the channel region from the light reflected from the fingerprint, the third portion disposed over the channel region, and the light shielding layer comprised of Cr/Cr_{X}O_{Y}.

28. The liquid crystal display device of claim 26, wherein the first switching thin film transistor comprises:
a channel region comprised of amorphous silicon; and
a light shielding layer, disposed over the channel region, for shielding the channel region from the light reflected from the fingerprint, and the light shielding layer comprised of Cr/Cr_{X}O_{Y}.
